(19) United States
(12) Patent Application Publication
(10) Pub. No.: US 2014/0029092 A1
(43) Pub. Date: Jan. 30, 2014

(54) OPTICAL SYSTEM, IN PARTICULAR A TELESCOPE

(71) Applicant: Carl Zeiss Sports Optics GmbH, (US)

(72) Inventors: Artur Hogele, Oberkochen (DE); Volker Tautz, Wetzlar (DE)

(73) Assignee: Carl Zeiss Sports Optics GmbH, Wetzlar (DE)

(21) Appl. No.: 13/856,557

(22) Filed: Apr. 4, 2013

Related U.S. Application Data
(60) Provisional application No. 61/620,048, filed on Apr. 4, 2012.

(30) Foreign Application Priority Data
Apr. 4, 2012 (DE) 102012205601.7

(51) Int. Cl. G02B 23/00; G02B 15/14

(52) U.S. Cl. CPC G02B 23/145; G02B 15/14
USPC 359/422; 359/432

(57) ABSTRACT

An optical system for generating an image of an object is provided. It has at least one objective, at least one lens erecting system and at least one eyepiece. The objective, the lens erecting system and the eyepiece are arranged along an optical axis of the optical system. The lens erecting system is arranged between the objective and the eyepiece. The objective has at least two optical units which, for magnifying the image, are configured to be displaceable along the optical axis.

The invention relates to an optical system for generating an image of an object, wherein the optical system is configured to magnify the image. In particular, the invention relates to an optical system in the form of a telescope, for example a telescopic sight, with a changeable magnification.

Terrestrial telescopes are used for terrestrial observation (for example within the field of sport or hunting). Such a telescope is distinguished by the virtue of the fact that an erecting system is arranged between an objective and an eyepiece, which erecting system generates an upright and true-sided image of an object. Here, the erecting system can be configured as a prism system or as a lens system. In the case of optical systems such as binoculars and spotting scopes, use is predominantly made of a prism erecting system, which has a linear magnification of −1. In general, a lens erecting system has a linear magnification not equal to −1. The linear magnification of the lens erecting system is negative.

In order to achieve a changeable magnification of an image of an object using an optical system, it is known, for example, to use an eyepiece with a changeable focal length. Optical systems with an eyepiece with a changeable focal length are disclosed in, for example, DE 1 057 793, DE 29 50 204 C2 and DE 38 13 992 A1. However, an optical system with an eyepiece with a changeable focal length is disadvantageous in that the subjective visual field (i.e. the visual field on the side of the eye) in the case of a set minimal magnification of the image, which is obtained by setting a maximum focal length of the eyepiece, is smaller than in the case of the set maximum magnification. Although the prior art known from DE 38 13 992 A1 tries to rectify this disadvantage by means of a field stop, the solution proposed therein leads to a smaller subjective visual field in the case of maximum magnification of the image than without the field stop with a changeable diameter.

The changeable magnification of the image can also be obtained using an objective with a changeable focal length. Thus, for example, U.S. Pat. No. 3,069,972 describes an optical system in the form of a telescope, which has an objective with a changeable focal length, a prism erecting system and an eyepiece with a fixed focal length. The objective is designed according to the principle of optical compensation and has two movable lens units, between which a fixed lens unit is arranged. As a result of moving the two movable lens units along the optical axis of the objective, the focal length of the objective is changed and hence a changeable magnification of the image is provided. However, a disadvantage in this case is that the position of an intermediate image after the objective varies and therefore the image of the telescope is not in focus over the whole magnification range. Hence there should be refocusing.

U.S. Pat. No. 3,286,592 has disclosed an objective with a changeable focal length for a telescope with a prism erecting system, which, however, operates according to the principle of mechanical compensation. The known objective has a first lens unit, which is fixedly arranged on an optical axis of the objective. Furthermore, the known objective has a second lens unit and a third lens unit, which are arranged movably independently of one another along the optical axis. However, a disadvantage in this case is that the second lens unit and the third lens unit have the same clear diameter as the first lens unit. Furthermore, the achievable zoom factor is only 2.4, which is rather small.

FR 1 427 872 has disclosed a telescope with an objective, a prism erecting system and an eyepiece with a fixed focal length. The objective of this known telescope likewise has a changeable focal length. The objective has a first lens unit, a second lens unit, a third lens unit and a fourth lens unit. The first lens unit and the fourth lens unit remained fixed on an optical axis of the objective during an adjustment of the focal length. The second lens unit and the third lens unit can be displaced independently of one another along the optical axis of the objective for the purposes of adjusting the focal length. A similar optical system is known from DE 7 041 703 U1.

U.S. Pat. No. 4,693,566 (corresponds to DE 34 32 682 A1), U.S. Pat. No. 4,871,241 (corresponds to DE 38 03 484 C2), U.S. Pat. No. 4,398,808 and DE 33 22 640 C2 (corresponds to U.S. Pat. No. 4,523,814) have disclosed optical systems in the form of photographic objectives with changeable focal lengths. The photographic objectives have a first lens unit, a second lens unit, a third lens unit and a fourth lens unit. In order to change the focal length, and hence for the changeable magnification of the image, the second lens unit and the third lens unit are respectively arranged displaceable independently of one another along an optical axis of each of the optical systems. A specific refractive power sequence is also provided for in the known photographic objectives. Thus, the first lens unit has positive refractive power, the second lens unit has negative refractive power, the third lens unit has positive refractive power and the fourth lens unit likewise has positive refractive power. However, the photographic objectives known from the aforementioned documents are not very suitable for the application in an optical system in the form of a telescope. This is because, firstly, the number of lenses used in the individual lens units of the photographic objectives is rather large. Secondly, the object-side field angle of the known photographic objectives is dimensioned so large for the application in telescopes that this leads to large diameters of the first lens unit. This is generally undesirable for an optical system in the form of a telescope.

Further optical systems in the form of photographic objectives having a changeable focal length are known from, for example, U.S. Pat. No. 4,281,906 (corresponds to DE 29 11 794 C2) and U.S. Pat. No. 4,518,228. The photographic objectives known from these documents have a first lens unit with positive refractive power, a second lens unit with negative refractive power, a third lens unit with negative refractive power and a fourth lens unit with positive refractive power. The second lens unit and the third lens unit are respectively arranged displaceable independently of one another along an optical axis of the respective photographic objectives for the purposes of adjusting the focal length. However, these photographic objectives are likewise not well-suited to telescopes as a result of their large dimensions and the large number of utilized lenses.

DE 10 2004 001 481 B4 and U.S. Pat. No. 6,563,642 B2 have disclosed optical systems respectively in the form of a telescope with an objective with a changeable focal length, a prism erecting system and an eyepiece with a fixed focal length. The objective with a changeable focal length has a first lens unit, a second lens unit and a third lens unit. The first lens unit remains fixed when the focal length is adjusted. By contrast, for the purposes of adjusting the focal length, the second lens unit and the third lens unit are arranged displaceable independently of one another along an optical axis of the respective objectives. However, the known optical systems do not render it possible to achieve a zoom factor of 6× or greater than 6×.

A further optical system in the form of a photographic objective with three lens units is known from, for example, U.S. Pat. No. 5,268,793. The known photographic objective has a changeable focal length. Furthermore, it is provided with a first lens unit, with a second lens unit and with a third lens unit. The second lens unit and the third lens unit are, for the purposes of adjusting the focal length, arranged displaceable independently of one another along the optical axis. The known photographic objective has a zoom factor of, for example, 8×. However, as a result of using aspherical lenses and as a result of a non-adapted focal length range, the known photographic objective is not suitable for telescopes.

An optical system in the form of a terrestrial telescope can for example also be equipped with a changeable linear magnification of an image using a lens erecting system. Thus, for example, the publication “Die Fernrohre and Entfernungsmesser” [“Telescopes and rangefinders”], 3rd edition 1959, pages 176-177 with FIG. 133 and pages 217-219 with FIG. 191 has disclosed an optical system in the form of a telescope, which has an objective with fixed focal length, a lens erecting system with changeable linear magnification and an eyepiece with fixed focal length. The lens erecting system has a changeable linear magnification.

It is provided with a first lens group and with a second lens group, wherein the first lens group and the second lens group are arranged displaceable independently of one another along an optical axis of the optical system.

In order to increase a zoom factor to 6×, EP 1 746 451 B1 has disclosed the use of a lens erecting system with a plurality of members. A scattering member is inserted between a second displaceable member (as seen from an object in the direction of an image capture unit) and an intermediate image generated after the lens erecting system.

U.S. Pat. No. 7,684,114 B2 has likewise disclosed an optical system with a lens erecting system, which has a first lens unit, a second lens unit and a third lens unit. The first lens unit, the second lens unit and the third lens unit are arranged displaceable independently of one another along an optical axis of the optical system for the purposes of setting the magnification of the image. The first lens unit and the second lens unit have positive refractive power. By contrast, the third lens unit has negative refractive power. Using the lens erecting system, it is possible to increase a zoom factor up to 7×.

The invention is now based on the object of specifying an optical system, more particularly in the form of a telescope, which has a changeable magnification of an image and by means of which it is also possible to achieve zoom factors of 8× or higher.

According to the invention, this is achieved by an optical system with the features of claim 1. Further features of the invention emerge from the following description, the following claims and/or the attached figures.

According to the invention, provision is made for an optical system for generating an image of an object, wherein the optical system is configured for the changeable magnification of the image. The optical system according to the invention has at least one objective, at least one lens erecting system and at least one eyepiece, wherein the objective, the lens erecting system and the eyepiece are arranged along an optical axis of the optical system and wherein the lens erecting system is arranged between the objective and the eyepiece. Expressed in other words, the optical system is in the following sequence from an object, in the direction of an image of the object: the objective—the lens erecting system—the eyepiece. Furthermore, provision is made in the optical system according to the invention for the objective to have at least two optical units which, for changing the magnification of the image, are configured to be displaceable along the optical axis. Here, an optical unit is understood to mean a unit which consists of an individual lens or has at least two lenses.

The optical system according to the invention is based on the concept of combining an objective with changeable focal length and a lens erecting system. The lens erecting system has a fixed linear magnification, which will still be discussed in more detail below. Deliberations have surprisingly shown that the lens erecting system can also be used for the magnification of the image of an object and can, at least in part, take over the magnification. In this fashion it is then possible to select the focal length of the objective to be small and to keep the first intermediate image small in terms of its diameter. The diameter of the optical system according to the invention can then be smaller compared to the prior art. Furthermore, deliberations have surprisingly shown that the optical system according to the invention can obtain zoom factors of up to 8× or larger.

The objective of the optical system according to the invention can have a specific configuration. Thus, in one exemplary embodiment of the optical system according to the invention, provision is additionally or alternatively made for—as seen from an object in the direction of the lens erecting system—the objective to have a first lens unit, a second lens unit, a third lens unit and a fourth lens unit. By way of example, the objective only has precisely the aforementioned four lens units. As an alternative to this, the objective can also have more than the aforementioned four lens units. The two optical units, which are displaceably arranged along the optical axis for the purposes of changing the magnification, are, in this exemplary embodiment, formed by the second lens unit and by the third lens unit. Above and also below, a lens unit is understood to mean a unit which consists of an individual lens or has at least two lenses.

In a further exemplary embodiment of the optical system according to the invention, provision is furthermore additionally or alternatively made for the first lens unit to have positive refractive power, the second lens unit to have negative refractive power and the fourth lens unit to have positive refractive power. Furthermore, provision is additionally or alternatively made for the third lens unit to have positive refractive power or negative refractive power. To this extent, the objective can, in an exemplary embodiment of the optical system according to the invention, have the refractive power sequence “+−++” or “+−−+”.

In the optical system according to the invention, provision is made for the first lens unit and the fourth lens unit to remain fixed on the optical axis and not to be moved when changing the focal length of the objective (i.e. when changing the magnification of the image of the optical system). However, for the purposes of changing the focal length, the second lens unit and/or the third lens unit are displaced independently of one another along the optical axis.

If the third lens unit has negative refractive power, this has expedient consequences on the movement sequence. It is then possible for the second lens unit and the third lens unit not to carry out an erecting movement or only carry out a small erecting movement during their movement sequence. Furthermore, it is possible to keep the diameter of the third lens unit small. If the third lens unit has negative refractive power, deliberations have shown that the (positive) refractive power of the fourth lens unit should be selected to be higher than would be the case if the third lens unit is provided with positive refractive power.

As already mentioned above, provision is made, in one exemplary embodiment of the optical system according to the invention, for the first lens unit and the fourth lens unit not to be moved during a change in the focal length of the objective. However, provision is now additionally or alternatively made in a further exemplary embodiment of the optical system according to the invention for the first lens unit or for at least components of the first lens unit to be moved for focusing purposes. Thus, for example, one embodiment provides for the first lens unit to be arranged in displaceable fashion along the optical axis for focusing purposes. As an alternative to this, provision is made for the first lens unit—as seen from the object in the direction of the eyepiece—to have at least one first optical member and at least one second optical member along the optical axis, wherein, for focusing purposes, the first optical member is arranged immovably on the optical axis and the second optical member is arranged movably along the optical axis. The arrangement of the first lens unit, which is responsible for focusing, in front of the second lens unit and the third lens unit, which are responsible for changing the focal length, is advantageous in that the position of the image along the optical axis is not displaced when the magnification of the image is changed. Hence, the image remains sharp over the whole magnification range. There therefore is no need for refocusing if the magnification is changed. If the first optical member is fixedly arranged on the optical axis during the focusing, and, for focusing purposes, only the second optical member is displaceable along the optical axis, this is advantageous for sealing the optical system. The probability of dirt being able to penetrate into the optical system is reduced by this measure. Furthermore, the structural length does not change during focusing.

In a further embodiment of the optical system according to the invention, provision is additionally or alternatively made for the lens erecting system to have a linear magnification with an absolute value of greater than 1. Expressed in other words, the lens erecting system has a linear magnification of less than (−1). As a result of this, the maximum diameter of a first intermediate image (which will still be explained in more detail below), which is obtained in the case of a small magnification, can be reduced. As a result of this, it is possible to provide thin optical systems (thin telescopes) for a magnification range of, for example, 1× to 8× or 1× to 10×.

In a further exemplary embodiment of the optical system according to the invention, provision is additionally or alternatively made for the lens erecting system—as seen from the object in the direction of the eyepiece—to have a first erecting lens unit and a second erecting lens unit along the optical axis and for the first erecting lens unit to have a positive refractive power. In addition or as an alternative to this, provision is made for the second erecting lens unit to have negative refractive power.

In a further exemplary embodiment of the optical system according to the invention, provision is additionally or alternatively made for at least one first intermediate image to be arranged between the objective and the lens erecting system. Furthermore—as seen from the object in the direction of the lens erecting system—a first field lens unit is arranged in front of or behind the first intermediate image, which field lens unit has positive refractive power. The first field lens unit deflects incident beams in such a way that they subsequently pass through the clear diameter of the lens erecting system. By way of example, the first field lens unit can consist of an individual lens or have at least two lenses.

In an in turn further embodiment of the optical system according to the invention, provision is additionally or alternatively made for a second intermediate image to be arranged between the lens erecting system and the eyepiece along the optical axis and for, as seen from the lens erecting system in the direction of the eyepiece, a second field lens unit, which has positive refractive power or negative refractive power, to be arranged in front of the second intermediate image. Here, provision is made for the second field lens unit to consist of an individual lens or to have at least two lenses. By way of example, what can be achieved by using a second field lens unit with negative refractive power is that the exit pupil lies far away from the eyepiece. By way of example, the distance between the eyepiece and the exit pupil then is greater than twice the eyepiece focal length. If the second field lens unit has positive refractive power, then it is possible, for example, to select a smaller eyepiece diameter.

In an in turn further exemplary embodiment of the optical system according to the invention, the optical system is embodied as a telescope. By way of example, it is embodied as a terrestrial telescope.

In the following text, the invention will be explained in more detail on the basis of exemplary embodiments. Here:

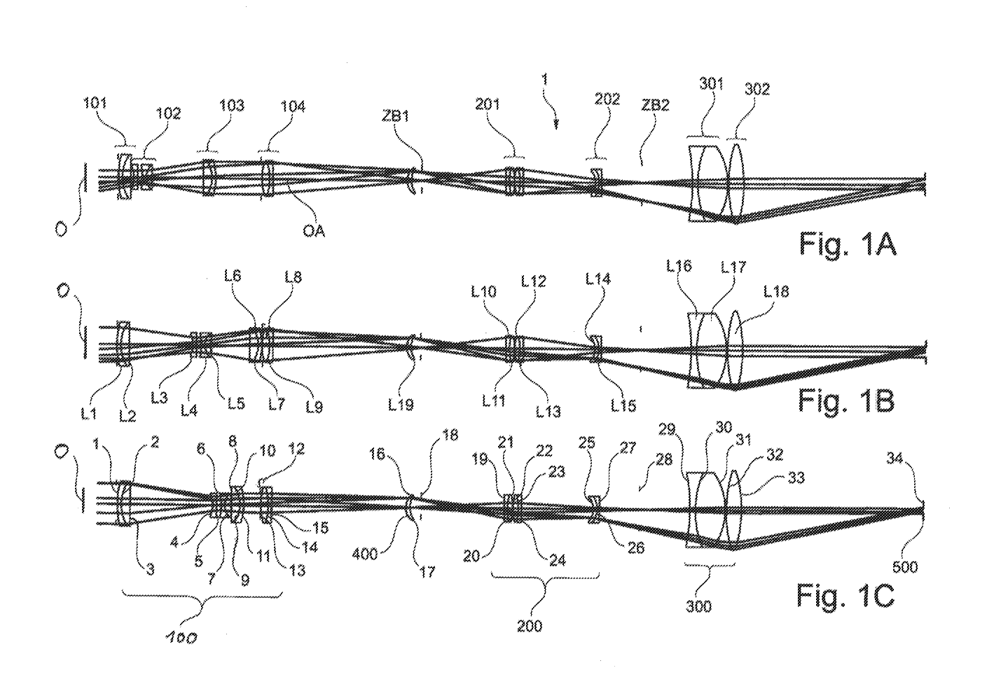

FIG. 1 show schematic illustrations of a first exemplary embodiment of a telescope according to the invention;

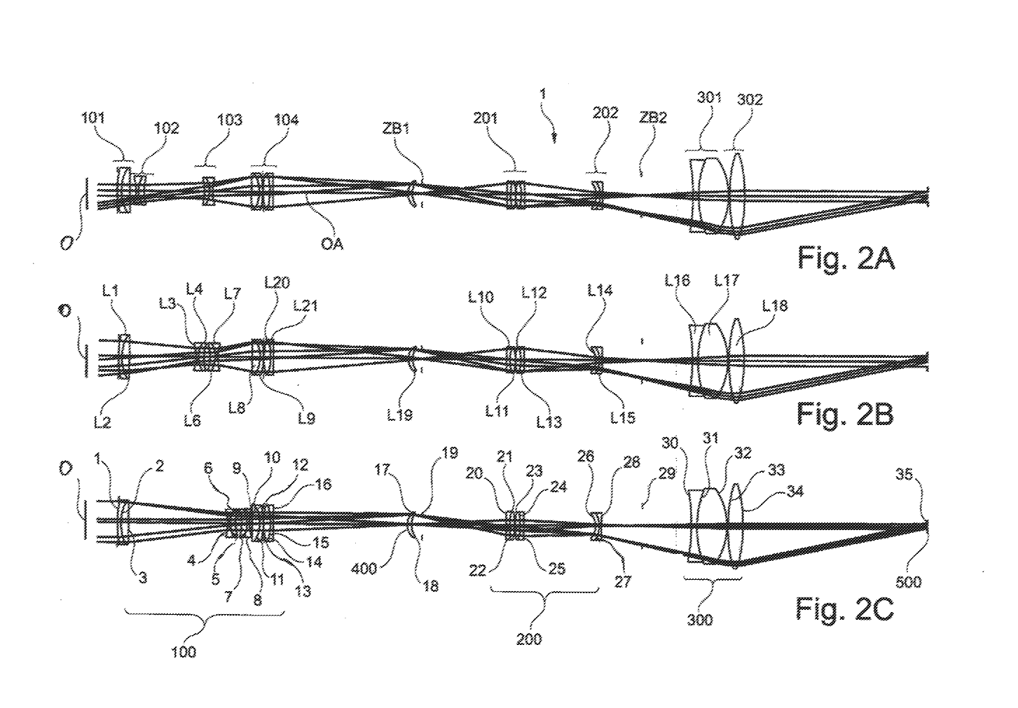

FIG. 2 show schematic illustrations of a second exemplary embodiment of a telescope according to the invention;

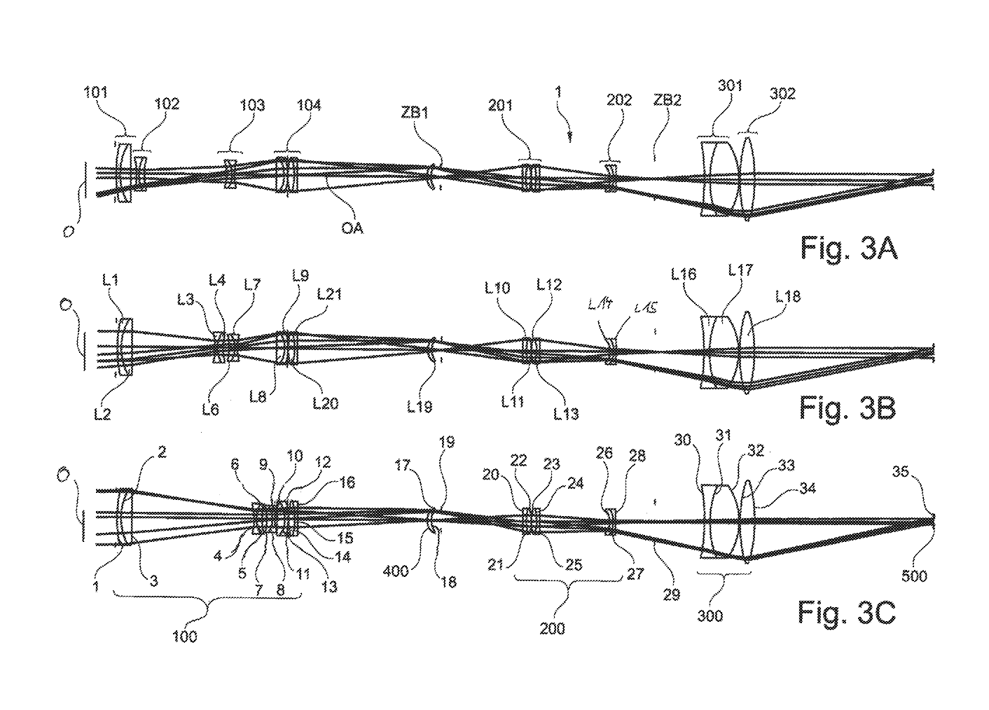

FIG. 3 show schematic illustrations of a third exemplary embodiment of a telescope according to the invention; and

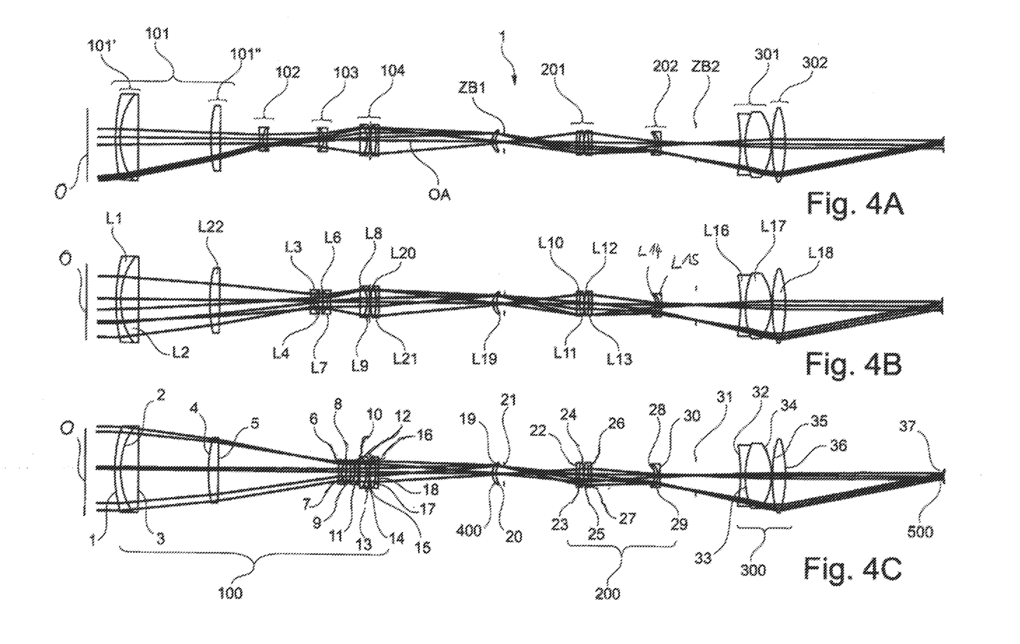

FIG. 4 show schematic illustrations of a fourth exemplary embodiment of a telescope according to the invention.

FIGS. 1A to 1C show a first exemplary embodiment of an optical system according to the invention in the form of a telescope 1, which is configured for the changeable magnification of an image of an object O. In order to set the magnification, the focal length of an objective 100 can be set. FIG. 1A shows a first focal length setting. FIG. 1B in turn shows a second focal length setting and FIG. 1C shows a third focal length setting of the telescope 1.

The telescope 1 has an optical axis OA, along which, from the object O in the direction of an exit pupil 500, the objective 100, a lens erecting system 200 and an eyepiece 300 are arranged. In other words, the lens erecting system 200 is arranged between the objective 100 and the eyepiece 300.

In the following text, the design of the objective 100 is discussed in more detail. The objective 100 has four lens units, namely—as seen from the object O in the direction of the lens erecting system 200—a first lens unit 101, a second lens unit 102, a third lens unit 103 and a fourth lens unit 104. The first lens unit 101 has positive refractive power. Furthermore, the second lens unit 102 has negative refractive power. Moreover, the third lens unit 103 has positive refractive power. The fourth lens unit 104 has positive refractive power. In this respect, the objective 100 in FIG. 1 has the refractive power sequence “+−++” in respect of the four lens units.

The first lens unit 101 has a first cemented component, which is formed by a first lens L1 and a second lens L2. The second lens unit 102 has three lenses, namely a third lens L3 and a second cemented component, which is composed of a fourth lens L4 and a fifth lens 5. The third lens unit 103 has a third cemented component, which is composed of a sixth lens L6 and a seventh lens L7. The fourth lens unit 104 likewise has a cemented component, namely a fourth cemented component which is composed of an eighth lens L8 and the ninth lens L9.

For changing the focal length of the objective 100, the second lens unit 102 and the third lens unit 103 are arranged displaceably along the optical axis OA. As already mentioned above, FIG. 1A shows the positions of the second lens unit 102 and the third lens unit 103 for the first focal length setting. FIG. 1B shows the positions of the second lens unit 102 and the third lens unit 103 for the second focal length setting. By contrast, FIG. 1C shows the positions of the second lens unit 102 and the third lens unit 103 for the third focal length setting. In the exemplary embodiment illustrated in FIG. 1, the first lens unit 101 and the fourth lens unit 104 are fixedly arranged on the optical axis OA. Hence, these two lens units are not moved when setting the focal length.

For focusing purposes, the first lens unit 101 is arranged movably along the optical axis OA. However, reference is explicitly made to the fact that the first lens unit 101 is not moved when setting the focal length.

In the following text, the lens erecting system 200 will be discussed in more detail. The lens erecting system 200 likewise has a plurality of lens units, namely a first erecting lens unit 201 with positive refractive power and a second erecting lens unit 202 with negative refractive power. Both the first erecting lens unit 201 and the second erecting lens unit 202 are fixedly arranged on the optical axis OA. The first erecting lens units 201 is provided with two cemented components, namely a fifth cemented component, which is formed by a tenth lens L10 and an eleventh lens 11, and a sixth cemented component, which is formed by a twelfth lens L12 and a thirteenth lens L13. The second erecting lens unit 202 has a seventh cemented component, which is composed of a fourteenth lens L14 and a fifteenth lens L15.

The lens erecting system 200 has a linear magnification with an absolute value of greater than 1. Expressed in other words, the lens erecting system 200 has a linear magnification of less than (−1). In the exemplary embodiment illustrated here, the linear magnification is for example (−2.2). In a further exemplary embodiment of the lens erecting system, the linear magnification lies in a range from (−2.5) to (−1.5). In an in turn further exemplary embodiment, the linear magnification lies in a range from (−4) to (−1).

In the following text, the eyepiece 300 will now be discussed in greater detail. The eyepiece 300 is provided with two lens units, namely a first eyepiece unit 301 and a second eyepiece unit 302. The first eyepiece unit 301 is embodied as eight cemented component, which is composed of a sixteenth lens L16 and a seventeenth lens L17. The second eyepiece unit 302 is formed by an individual lens, namely an eighteenth lens L18.

In its beam path, the telescope 1 has two intermediate images. Thus, a first intermediate image ZB1 is arranged between the objective 100 and the lens erecting system 200. Furthermore, a second intermediate image ZB2 is arranged between the lens erecting system 200 and the eyepiece 300. In the exemplary embodiment illustrated in FIG. 1, from the object O in the direction of the lens erecting system 200, a first field lens unit 400 is arranged on the optical axis OA, which first field lens unit is composed of a nineteenth lens L19. The first field lens unit 400 has positive refractive power. What the first field lens unit 400 brings about is that incident beams are deflected in the direction of the optical axis OA. This ensures that the beams then pass through the clear diameter of the lens erecting system 200.

The lens erecting system 200 is also used for magnifying the image of the object O. In this fashion, it is then possible to select the focal length of the objective 100 accordingly and to keep the first intermediate image ZB1 small in terms of its diameter. The diameter of the telescope 1 can then be smaller compared to the prior art. As a result of this, the telescope 1 becomes quite “thin”. Furthermore, deliberations have surprisingly shown that it is possible to obtain zoom factors of up to 8× or greater using the telescope 1, for example a magnification range of 1× to 8× or 1× to 10×.

A field stop can be arranged on the first intermediate image ZB1 or on the second intermediate image ZB2. As an alternative to this, a reticle can be arranged here.

The telescope 1 in accordance with FIG. 1 has the properties summarized in the following table.

TABLE 1

| Surface | | Thicknesses | | | | | |
|---|---|---|---|---|---|---|---|
| Number | Radii | Distances | Glass | nₑ | n_{C′} | n_{F′} | n_{g} |
| 1 | 45.123 | 1.800 | S-NBH51 | 1.754530 | 1.744240 | 1.765740 | 1.776820 |
| 2 | 22.446 | 4.400 | S-PHM53 | 1.605200 | 1.600640 | 1.609930 | 1.614380 |
| 3 | −100.291 | 1.498 | | 1.000000 | 1.000000 | 1.000000 | 1.000000 |
| | | 30.271 | | | | | |
| | | 40.441 | | | | | |
| 4 | −15.587 | 1.400 | S-PHM53 | 1.605200 | 1.600640 | 1.609930 | 1.614380 |
| 5 | 106.168 | 3.000 | | 1.000000 | 1.000000 | 1.000000 | 1.000000 |
| 6 | −15.587 | 1.400 | N-BAF51 | 1.655690 | 1.648600 | 1.663280 | 1.670650 |
| 7 | 9.797 | 2.800 | N-SF4 | 1.761640 | 1.748420 | 1.776470 | 1.791580 |
| 8 | INF | 24.844 | | 1.000000 | 1.000000 | 1.000000 | 1.000000 |
| | | 18.482 | | | | | |
| | | 0.494 | | | | | |
| 9 | INF | 4.400 | S-PHM53 | 1.605200 | 1.600640 | 1.609930 | 1.614380 |
| 10 | −12.790 | 1.600 | S-NBH51 | 1.754530 | 1.744240 | 1.765740 | 1.776820 |
| 11 | −23.952 | 22.858 | | 1.000000 | 1.000000 | 1.000000 | 1.000000 |
| | | 0.452 | | | | | |
| | | 8.265 | | | | | |
| 12 | INF | 0.142 | | 1.000000 | 1.000000 | 1.000000 | 1.000000 |
| 13 | 43.086 | 3.200 | S-PHM53 | 1.605200 | 1.600640 | 1.609930 | 1.614380 |
| 14 | −32.059 | 1.600 | S-NBH51 | 1.754530 | 1.744240 | 1.765740 | 1.776820 |
| 15 | −199.845 | 66.070 | | 1.000000 | 1.000000 | 1.000000 | 1.000000 |
| 16 | 8.133 | 2.000 | S-PHM53 | 1.605200 | 1.600640 | 1.609930 | 1.614380 |
| 17 | 11.466 | 5.000 | | 1.000000 | 1.000000 | 1.000000 | 1.000000 |
| 18 | INF | 42.673 | | 1.000000 | 1.000000 | 1.000000 | 1.000000 |
| 19 | 72.635 | 1.400 | S-NBH51 | 1.754530 | 1.744240 | 1.765740 | 1.776820 |
| 20 | 25.218 | 2.800 | S-PHM53 | 1.605200 | 1.600640 | 1.609930 | 1.614380 |
| 21 | −33.949 | 0.142 | | 1.000000 | 1.000000 | 1.000000 | 1.000000 |
| 22 | 25.540 | 3.000 | S-PHM53 | 1.605200 | 1.600640 | 1.609930 | 1.614380 |
| 23 | −34.248 | 1.400 | S-NBH51 | 1.754530 | 1.744240 | 1.765740 | 1.776820 |
| 24 | INF | 36.947 | | 1.000000 | 1.000000 | 1.000000 | 1.000000 |
| 25 | −10.934 | 2.000 | N-SF4 | 1.761640 | 1.748420 | 1.776470 | 1.791580 |
| 26 | −8.608 | 1.400 | S-PHM53 | 1.605200 | 1.600640 | 1.609930 | 1.614380 |
| 27 | −62.336 | 20.270 | | 1.000000 | 1.000000 | 1.000000 | 1.000000 |
| 28 | INF | 25.525 | | 1.000000 | 1.000000 | 1.000000 | 1.000000 |
| 29 | −86.331 | 2.500 | S-TIH6 | 1.812640 | 1.797520 | 1.829740 | 1.847290 |
| 30 | 48.688 | 15.000 | S-BSL7 | 1.518250 | 1.514250 | 1.522360 | 1.526210 |
| 31 | −30.710 | 0.200 | | 1.000000 | 1.000000 | 1.000000 | 1.000000 |
| 32 | 65.987 | 7.500 | S-LAL7 | 1.654250 | 1.648750 | 1.659970 | 1.665370 |
| 33 | −92.347 | 90.000 | | 1.000000 | 1.000000 | 1.000000 | 1.000000 |
| 34 | INF | | | | | | |

The individual surfaces of the individual optical units (lenses, stops and intermediate image planes) and their radii are specified in the aforementioned table. Furthermore, the distance from the apex point of a first surface to the apex point of the next surface is specified. This likewise reproduces the thickness of the individual optical units. The various distances between the surfaces 3 and 4, 8 and 9, and 11 and 12 are the distances between said surfaces in the first focal length setting, in the second focal length setting and in the third focal length setting. Furthermore, n denotes the refractive index, wherein this is specified for various wavelengths (spectral lines). Moreover, the glass type of the respective optical unit is specified, wherein the notation of the glass types relates to the glass types by OHARA and SCHOTT.

The zoom factor in this exemplary embodiment is 8×. The magnification in the first focal length setting is 1.086. In the second focal length setting, the magnification is 3.074. Furthermore, the magnification in the third focal length setting is 8.692.

FIGS. 2A to 2C show a second exemplary embodiment of an optical system according to the invention in the form of a telescope 1, which is configured for the changeable magnification of an image of an object O. The exemplary embodiment in FIG. 2 is based on the exemplary embodiment in FIG. 1. The same components are provided with the same reference sign. In this respect, reference is first of all made to all the explanations made above.

The focal length of the objective 100 can once again be set. FIG. 2A shows a first focal length setting. FIG. 2B in turn shows a second focal length setting and FIG. 2C shows a third focal length setting of the telescope 1.

In contrast to the exemplary embodiment in FIG. 1, the exemplary embodiment in FIG. 2 has a different refractive power sequence in respect of the lens units of the objective 100. The first lens unit 101 has positive refractive power. Furthermore, the second lens unit 102 has negative refractive power. Moreover, the third lens unit 103 has negative refractive power. The fourth lens unit 104 has positive refractive power. In this respect, the objective 100 of FIG. 2 has the refractive power sequence “+−−+” in respect of the four lens units.

Furthermore, in contrast to the exemplary embodiment in FIG. 1, the second lens unit 102 of the objective 100 in the exemplary embodiment of FIG. 2 only has two lenses, namely the third lens L3 and the fourth lens L4. The design of the fourth lens unit 104 is likewise different. Thus, the fourth lens unit 104 in the exemplary embodiment of FIG. 2 has two cemented components, wherein the one cemented component is composed of the eighth lens L8 and the ninth lens L9 and wherein the other cemented component is composed of a twentieth lens L20 and a twenty-first lens L21.

The telescope 1 in accordance with FIG. 2 has the properties summarized in the following table.

TABLE 2

| Surface | | Thicknesses | | | | | |
|---|---|---|---|---|---|---|---|
| Number | Radii | Distances | Glass | nₑ | n_{C′} | n_{F′} | n_{g} |
| 1 | 49.241 | 2.000 | S-NBH51 | 1.754530 | 1.744240 | 1.765740 | 1.776820 |
| 2 | 24.992 | 3.800 | S-PHM53 | 1.605200 | 1.600640 | 1.609930 | 1.614380 |
| 3 | −163.498 | 2.734 | | 1.000000 | 1.000000 | 1.000000 | 1.000000 |
| | | 31.569 | | | | | |
| | | 47.261 | | | | | |
| 4 | −31.641 | 1.400 | N-BAF4 | 1.608970 | 1.602220 | 1.616240 | 1.623360 |
| 5 | 12.192 | 2.500 | N-SF6 | 1.812660 | 1.797490 | 1.829800 | 1.847380 |
| 6 | 27.487 | 29.398 | | 1.000000 | 1.000000 | 1.000000 | 1.000000 |
| | | 2.858 | | | | | |
| | | 2.912 | | | | | |
| 7 | −27.487 | 2.500 | N-SF6 | 1.812660 | 1.797490 | 1.829800 | 1.847380 |
| 8 | −12.192 | 1.400 | N-BAF4 | 1.608970 | 1.602220 | 1.616240 | 1.623360 |
| 9 | 31.641 | 19.068 | | 1.000000 | 1.000000 | 1.000000 | 1.000000 |
| | | 16.778 | | | | | |
| | | 1.030 | | | | | |
| 10 | 79.086 | 3.800 | S-PHM53 | 1.605200 | 1.600640 | 1.609930 | 1.614380 |
| 11 | −16.190 | 1.400 | S-NBH51 | 1.754530 | 1.744240 | 1.765740 | 1.776820 |
| 12 | −31.926 | 0.100 | | 1.000000 | 1.000000 | 1.000000 | 1.000000 |
| 13 | INF | 0.100 | | 1.000000 | 1.000000 | 1.000000 | 1.000000 |
| 14 | 43.086 | 3.200 | S-PHM53 | 1.605200 | 1.600640 | 1.609930 | 1.614380 |
| 15 | −32.059 | 1.600 | S-NBH51 | 1.754530 | 1.744240 | 1.765740 | 1.776820 |
| 16 | −199.845 | 66.070 | | 1.000000 | 1.000000 | 1.000000 | 1.000000 |
| 17 | 8.133 | 2.000 | S-PHM53 | 1.605200 | 1.600640 | 1.609930 | 1.614380 |
| 18 | 11.466 | 5.000 | | 1.000000 | 1.000000 | 1.000000 | 1.000000 |
| 19 | INF | 42.673 | | 1.000000 | 1.000000 | 1.000000 | 1.000000 |
| 20 | 72.635 | 1.400 | S-NBH51 | 1.754530 | 1.744240 | 1.765740 | 1.776820 |
| 21 | 25.218 | 2.800 | S-PHM53 | 1.605200 | 1.600640 | 1.609930 | 1.614380 |
| 22 | −33.949 | 0.142 | | 1.000000 | 1.000000 | 1.000000 | 1.000000 |
| 23 | 25.540 | 3.000 | S-PHM53 | 1.605200 | 1.600640 | 1.609930 | 1.614380 |
| 24 | −34.248 | 1.400 | S-NBH51 | 1.754530 | 1.744240 | 1.765740 | 1.776820 |
| 25 | INF | 36.947 | | 1.000000 | 1.000000 | 1.000000 | 1.000000 |
| 26 | −10.934 | 2.000 | N-SF4 | 1.761640 | 1.748420 | 1.776470 | 1.791580 |
| 27 | −8.608 | 1.400 | S-PHM53 | 1.605200 | 1.600640 | 1.609930 | 1.614380 |
| 28 | −62.336 | 20.270 | | 1.000000 | 1.000000 | 1.000000 | 1.000000 |
| 29 | INF | 25.525 | | 1.000000 | 1.000000 | 1.000000 | 1.000000 |
| 30 | −86.331 | 2.500 | S-TIH6 | 1.812640 | 1.797520 | 1.829740 | 1.847290 |
| 31 | 48.688 | 15.000 | S-BSL7 | 1.518250 | 1.514250 | 1.522360 | 1.526210 |
| 32 | −30.710 | 0.200 | | 1.000000 | 1.000000 | 1.000000 | 1.000000 |
| 33 | 65.987 | 7.500 | S-LAL7 | 1.654250 | 1.648750 | 1.659970 | 1.665370 |
| 34 | −92.347 | 90.000 | | 1.000000 | 1.000000 | 1.000000 | 1.000000 |
| 35 | INF | | | | | | |

The individual surfaces of the individual optical units (lenses, stops and intermediate image planes) and their radii are specified in the aforementioned table. Furthermore, the distance from the apex point of a first surface to the apex point of the next surface is specified. This likewise reproduces the thickness of the individual optical units. The various distances between the surfaces 3 and 4, 6 and 7, and 9 and 10 are the distances between said surfaces in the first focal length setting, in the second focal length setting and in the third focal length setting. The surface 13 is a stop in the fourth lens unit 104. Furthermore, n denotes the refractive index, wherein this is specified for various wavelengths (spectral lines). Moreover, the glass type of the respective optical unit is specified, wherein the notation of the glass types relates to the glass types by OHARA and SCHOTT.

The zoom factor in this exemplary embodiment is 8×. The magnification in the first focal length setting is 1.086. In the second focal length setting, the magnification is 3.073. Furthermore, the magnification in the third focal length setting is 8.690.

FIGS. 3A to 3C show a third exemplary embodiment of an optical system according to the invention in the form of a telescope 1, which is configured for the changeable magnification of an image of an object O. The exemplary embodiment in FIG. 3 is based on the exemplary embodiment in FIG. 2. The same components are provided with the same reference sign. In this respect, reference is first of all made to all the explanations made above. In principle, it is only distinguished by the following configuration of the individual lenses, which are summarized in the table.

TABLE 3

| Surface | | Thicknesses | | | | | |
|---|---|---|---|---|---|---|---|
| Number | Radii | Distances | Glass | nₑ | n_{C′} | n_{F′} | n_{g} |
| 1 | 60.395 | 2.000 | S-NBH51 | 1.754530 | 1.744240 | 1.765740 | 1.776820 |
| 2 | 31.321 | 5.300 | S-PHM53 | 1.605200 | 1.600640 | 1.609930 | 1.614380 |
| 3 | −176.695 | 2.893 | | 1.000000 | 1.000000 | 1.000000 | 1.000000 |
| | | 41.482 | | | | | |
| | | 60.958 | | | | | |
| 4 | −25.161 | 1.500 | N-BAF4 | 1.608970 | 1.602220 | 1.616240 | 1.623360 |
| 5 | 14.665 | 2.500 | N-SF6 | 1.812660 | 1.797490 | 1.829800 | 1.847380 |
| 6 | 38.020 | 40.508 | | 1.000000 | 1.000000 | 1.000000 | 1.000000 |
| | | 2.933 | | | | | |
| | | 2.198 | | | | | |
| 7 | −38.020 | 2.500 | N-SF6 | 1.812660 | 1.797490 | 1.829800 | 1.847380 |
| 8 | −14.665 | 1.500 | N-BAF4 | 1.608970 | 1.602220 | 1.616240 | 1.623360 |
| 9 | 25.161 | 21.000 | | 1.000000 | 1.000000 | 1.000000 | 1.000000 |
| | | 19.984 | | | | | |
| | | 1.246 | | | | | |
| 10 | 60.236 | 3.800 | S-PHM53 | 1.605200 | 1.600640 | 1.609930 | 1.614380 |
| 11 | −18.302 | 1.500 | S-NBH51 | 1.754530 | 1.744240 | 1.765740 | 1.776820 |
| 12 | −38.743 | 0.100 | | 1.000000 | 1.000000 | 1.000000 | 1.000000 |
| 13 | INF | 0.100 | | 1.000000 | 1.000000 | 1.000000 | 1.000000 |
| 14 | 43.086 | 3.000 | S-PHM53 | 1.605200 | 1.600640 | 1.609930 | 1.614380 |
| 15 | −32.059 | 1.600 | S-NBH51 | 1.754530 | 1.744240 | 1.765740 | 1.776820 |
| 16 | −199.845 | 66.070 | | 1.000000 | 1.000000 | 1.000000 | 1.000000 |
| 17 | 8.133 | 2.000 | S-PHM53 | 1.605200 | 1.600640 | 1.609930 | 1.614380 |
| 18 | 11.466 | 5.000 | | 1.000000 | 1.000000 | 1.000000 | 1.000000 |
| 19 | INF | 42.673 | | 1.000000 | 1.000000 | 1.000000 | 1.000000 |
| 20 | 72.635 | 1.400 | S-NBH51 | 1.754530 | 1.744240 | 1.765740 | 1.776820 |
| 21 | 25.218 | 2.800 | S-PHM53 | 1.605200 | 1.600640 | 1.609930 | 1.614380 |
| 22 | −33.949 | 0.142 | | 1.000000 | 1.000000 | 1.000000 | 1.000000 |
| 23 | 25.540 | 3.000 | S-PHM53 | 1.605200 | 1.600640 | 1.609930 | 1.614380 |
| 24 | −34.248 | 1.400 | S-NBH51 | 1.754530 | 1.744240 | 1.765740 | 1.776820 |
| 25 | INF | 36.947 | | 1.000000 | 1.000000 | 1.000000 | 1.000000 |
| 26 | −10.934 | 2.000 | N-SF4 | 1.761640 | 1.748420 | 1.776470 | 1.791580 |
| 27 | −8.608 | 1.400 | S-PHM53 | 1.605200 | 1.600640 | 1.609930 | 1.614380 |
| 28 | −62.336 | 20.270 | | 1.000000 | 1.000000 | 1.000000 | 1.000000 |
| 29 | INF | 25.525 | | 1.000000 | 1.000000 | 1.000000 | 1.000000 |
| 30 | −86.331 | 2.500 | S-TIH6 | 1.812640 | 1.797520 | 1.829740 | 1.847290 |
| 31 | 48.688 | 15.000 | S-BSL7 | 1.518250 | 1.514250 | 1.522360 | 1.526210 |
| 32 | −30.710 | 0.200 | | 1.000000 | 1.000000 | 1.000000 | 1.000000 |
| 33 | 65.987 | 7.500 | S-LAL7 | 1.654250 | 1.648750 | 1.659970 | 1.665370 |
| 34 | −92.347 | 90.000 | | 1.000000 | 1.000000 | 1.000000 | 1.000000 |
| 35 | INF | | | | | | |

The individual surfaces of the individual optical units (lenses, stops and intermediate image planes) and their radii are specified in the aforementioned table. Furthermore, the distance from the apex point of a first surface to the apex point of the next surface is specified. This likewise reproduces the thickness of the individual optical units. The various distances between the surfaces 3 and 4, 6 and 7, and 9 and 10 are the distances between said surfaces in the first focal length setting, in the second focal length setting and in the third focal length setting. The surface 13 is a stop in the fourth lens unit 104. Furthermore, n denotes the refractive index, wherein this is specified for various wavelengths (spectral lines). Moreover, the glass type of the respective optical unit is specified, wherein the notation of the glass types relates to the glass types by OHARA and SCHOTT.

The zoom factor in this exemplary embodiment is 12×. The magnification in the first focal length setting is 0.886. In the second focal length setting, the magnification is 3.073. Furthermore, the magnification in the third focal length setting is 10.644.

The two exemplary embodiments in accordance with FIGS. 2 and 3 have a property in respect of the motion sequence which is due to the third lens unit 103. It is then possible for the second lens unit 102 and the third lens unit 103 not to carry out an erecting movement or only to carry out a small erecting movement during their motion sequence. Furthermore, it is possible to keep the diameter of the third lens unit 103 smaller as distinguished from the exemplary embodiment in FIG. 1. However, the refractive power of the fourth lens unit 104 in the exemplary embodiments of FIGS. 2 and 3 should be selected to be greater than the refractive power thereof in the exemplary embodiment from FIG. 1. This may cause an increase in the number of lenses, as explained above.

FIGS. 4A to 4C show a fourth exemplary embodiment of an optical system according to the invention in the form of a telescope 1, which is configured for the changeable magnification of an image of an object O. The exemplary embodiment in FIG. 4 is based on the exemplary embodiment in FIG. 2. The same components are provided with the same reference sign. In this respect, reference is first of all made to all the explanations made above. In contrast to the exemplary embodiment in accordance with FIG. 2, the exemplary embodiment in accordance with FIG. 4 has a first lens unit 101 which is composed of a first lens subunit 101′ and a second lens subunit 101″. The first lens subunit 101′ is composed of the first lens L1 and the second lens L2. The second lens subunit 101″ is formed by a twenty-second lens L22.

The exemplary embodiment illustrated in FIG. 4 is a telescope 1 with internal focusing. Thus, for focusing, provision is made for the first lens subunit 101′ to be fixedly arranged on the optical axis OA and, for focusing, the second lens subunit 101″ is moved along the optical axis OA.

The first lens subunit 101′ has positive refractive power. The second lens subunit 101″ is provided with positive refractive power. As an alternative to this, the second lens subunit 101″ can also be provided with negative refractive power. In the case of a positive refractive power of the second lens subunit 101″, the second lens subunit 101″ is displaced in the direction of the first lens subunit 101′ for focusing from a large object distance (infinity) to a near object distance. If the second lens subunit 101″ has negative refractive power, it is displaced in the direction of the eyepiece 300 for focusing from a large object distance (infinity) to a near object distance.

Further properties of this exemplary embodiment are summarized in the following table.

TABLE 4

| Surface | | Thicknesses | | | | | |
|---|---|---|---|---|---|---|---|
| Number | Radii | Distances | Glass | nₑ | n_{C′} | n_{F′} | n_{g} |
| 1 | 66.835 | 3.000 | S-NBH51 | 1.754530 | 1.744240 | 1.765740 | 1.776820 |
| 2 | 40.502 | 10.000 | S-PHM53 | 1.605200 | 1.600640 | 1.609930 | 1.614380 |
| 3 | 198.570 | 40.077 | | 1.000000 | 1.000000 | 1.000000 | 1.000000 |
| 4 | 100.000 | 5.000 | N-FK5 | 1.489140 | 1.485690 | 1.492660 | 1.495930 |
| 5 | 400.000 | 22.734 | | 1.000000 | 1.000000 | 1.000000 | 1.000000 |
| | | 51.569 | | | | | |
| | | 67.261 | | | | | |
| 6 | −31.641 | 1.400 | N-BAF4 | 1.608970 | 1.602220 | 1.616240 | 1.623360 |
| 7 | 12.192 | 2.500 | N-SF6 | 1.812660 | 1.797490 | 1.829800 | 1.847380 |
| 8 | 27.487 | 29.398 | | 1.000000 | 1.000000 | 1.000000 | 1.000000 |
| | | 2.858 | | | | | |
| | | 2.912 | | | | | |
| 9 | −27.487 | 2.500 | N-SF6 | 1.812660 | 1.797490 | 1.829800 | 1.847380 |
| 10 | −12.192 | 1.400 | N-BAF4 | 1.608970 | 1.602220 | 1.616240 | 1.623360 |
| 11 | 31.641 | 19.068 | | 1.000000 | 1.000000 | 1.000000 | 1.000000 |
| | | 16.778 | | | | | |
| | | 1.030 | | | | | |
| 12 | 79.086 | 3.800 | S-PHM53 | 1.605200 | 1.600640 | 1.609930 | 1.614380 |
| 13 | −16.190 | 1.400 | S-NBH51 | 1.754530 | 1.744240 | 1.765740 | 1.776820 |
| 14 | −31.926 | 0.100 | | 1.000000 | 1.000000 | 1.000000 | 1.000000 |
| 15 | INF | 0.100 | | 1.000000 | 1.000000 | 1.000000 | 1.000000 |
| 16 | 43.086 | 3.200 | S-PHM53 | 1.605200 | 1.600640 | 1.609930 | 1.614380 |
| 17 | −32.059 | 1.600 | S-NBH51 | 1.754530 | 1.744240 | 1.765740 | 1.776820 |
| 18 | −199.845 | 66.070 | | 1.000000 | 1.000000 | 1.000000 | 1.000000 |
| 19 | 8.133 | 2.000 | S-PHM53 | 1.605200 | 1.600640 | 1.609930 | 1.614380 |
| 20 | 11.466 | 5.000 | | 1.000000 | 1.000000 | 1.000000 | 1.000000 |
| 21 | INF | 42.673 | | 1.000000 | 1.000000 | 1.000000 | 1.000000 |
| 22 | 72.635 | 1.400 | S-NBH51 | 1.754530 | 1.744240 | 1.765740 | 1.776820 |
| 23 | 25.218 | 2.800 | S-PHM53 | 1.605200 | 1.600640 | 1.609930 | 1.614380 |
| 24 | −33.949 | 0.142 | | 1.000000 | 1.000000 | 1.000000 | 1.000000 |
| 25 | 25.540 | 3.000 | S-PHM53 | 1.605200 | 1.600640 | 1.609930 | 1.614380 |
| 26 | −34.248 | 1.400 | S-NBH51 | 1.754530 | 1.744240 | 1.765740 | 1.776820 |
| 27 | INF | 36.947 | | 1.000000 | 1.000000 | 1.000000 | 1.000000 |
| 28 | −10.934 | 2.000 | N-SF4 | 1.761640 | 1.748420 | 1.776470 | 1.791580 |
| 29 | −8.608 | 1.400 | S-PHM53 | 1.605200 | 1.600640 | 1.609930 | 1.614380 |
| 30 | −62.336 | 20.270 | | 1.000000 | 1.000000 | 1.000000 | 1.000000 |
| 31 | INF | 25.525 | | 1.000000 | 1.000000 | 1.000000 | 1.000000 |
| 32 | −86.331 | 2.500 | S-TIH6 | 1.812640 | 1.797520 | 1.829740 | 1.847290 |
| 33 | 48.688 | 15.000 | S-BSL7 | 1.518250 | 1.514250 | 1.522360 | 1.526210 |
| 34 | −30.710 | 0.200 | | 1.000000 | 1.000000 | 1.000000 | 1.000000 |
| 35 | 65.987 | 7.500 | S-LAL7 | 1.654250 | 1.648750 | 1.659970 | 1.665370 |
| 36 | −92.347 | 90.000 | | 1.000000 | 1.000000 | 1.000000 | 1.000000 |
| 37 | INF | | | 1.000000 | 1.000000 | 1.000000 | 1.000000 |

The individual surfaces of the individual optical units (lenses, stops and intermediate image planes) and their radii are specified in the aforementioned table. Furthermore, the distance from the apex point of a first surface to the apex point of the next surface is specified. This likewise reproduces the thickness of the individual optical units. The various distances between the surfaces 5 and 6, 8 and 9, and 12 are the distances between said surfaces in the first focal length setting, in the second focal length setting and in the third focal length setting. Furthermore, n denotes the refractive index, wherein this is specified for various wavelengths (spectral lines). Moreover, the glass type of the respective optical unit is specified, wherein the notation of the glass types relates to the glass types by OHARA and SCHOTT.

The zoom factor in this exemplary embodiment is 8×. The magnification in the first focal length setting is 1.864. In the second focal length setting, the magnification is 5.275. Furthermore, the magnification in the third focal length setting is 14.920.

### LIST OF REFERENCE SIGNS

1 Optical system (telescope)
100 Objective
101 First lens unit
101′ First lens subunit
101″ Second lens subunit
102 Second lens unit
103 Third lens unit
104 Fourth lens unit
200 Lens erecting system
201 First erecting lens unit
202 Second erecting lens unit
300 Eyepiece
301 First eyepiece unit
302 Second eyepiece unit
400 First field lens unit
401 Second field lens unit
500 Exit pupil
ZB1 First intermediate image 1
ZB2 Second intermediate image 2
O Object
OA Optical axis
ZB1 First intermediate image
ZB2 Second intermediate image
L1 First lens
L2 Second lens
L3 Third lens
L4 Fourth lens
L5 Fifth lens
L6 Sixth lens
L7 Seventh lens
L8 Eighth lens
L9 Ninth lens
L10 Tenth lens
L11 Eleventh lens
L12 Twelfth lens
L13 Thirteenth lens
L14 Fourteenth lens
L15 Fifteenth lens
L16 Sixteenth lens
L17 Seventeenth lens
L18 Eighteenth lens
L19 Nineteenth lens
L20 Twentieth lens
L21 Twenty-first lens
L22 Twenty-second lens

1-12. (canceled)

13. An optical system for generating an image of an object, wherein the optical system is embodied for the changeable magnification of the image, the optical system comprising:
at least one objective;
at least one lens erecting system;
at least one eyepiece, wherein the objective, the lens erecting system and the eyepiece are arranged along an optical axis of the optical system, and wherein the lens erecting system is arranged between the objective and the eyepiece, and
wherein the objective includes at least two optical units which, for magnifying the image, are configured to be displaceable along the optical axis.

14. The optical system according to claim 13, wherein, as seen from an object in the direction of the lens erecting system, the objective has a first lens unit, a second lens unit, a third lens unit and a fourth lens unit, and wherein the two optical units are formed by the second lens unit and by the third lens unit.

15. The optical system according to claim 14, wherein:
the first lens unit has positive refractive power,
the second lens unit has negative refractive power, and
the fourth lens unit has positive refractive power.

16. The optical system according to claim 14, wherein the third lens unit has positive refractive power or negative refractive power.

17. The optical system according to claim 14, further comprising one of the following features:
(i) the first lens unit is arranged in displaceable fashion along the optical axis for focusing purposes, or
(ii) as seen from an object in the direction of the eyepiece, the first lens unit has at least one first optical member and at least one second optical member along the optical axis, wherein, for focusing the image, the first optical member is arranged immovably on the optical axis and the second optical member is arranged movably along the optical axis.

18. The optical system according to claim 14, wherein the fourth lens unit is fixedly arranged on the optical axis.

19. The optical system according to claim 13, wherein the lens erecting system has a linear magnification with an absolute value of greater than 1.

20. The optical system according to claim 1, wherein, as seen from an object in the direction of the eyepiece, the lens erecting system has a first erecting lens unit and a second erecting lens unit along the optical axis, and wherein the first erecting lens unit has a positive refractive power.

21. The optical system according to claim 20, wherein the second erecting lens unit has negative refractive power.

22. The optical system according to claim 13, further comprising:
at least one first intermediate image arranged between the objective and the lens erecting system; and
as seen from the objective in the direction of the lens erecting system, a first field lens unit, which has positive refractive power, arranged in front of or behind the first intermediate image.

23. The optical system according to claim 13, further comprising:
a second intermediate image arranged between the lens erecting system and the eyepiece along the optical axis; and
as seen from the lens erecting system in the direction of the eyepiece, a second field lens unit, which has positive refractive power or negative refractive power, arranged in front of the second intermediate image.

24. The optical system according to claim 13, wherein the optical system is embodied as a telescope.

25. The optical system according to claim 24, wherein the optical system is embodied as a terrestrial telescope.

26. The optical system according to claim 13, wherein, as seen from an object in the direction of the lens erecting system, the objective has a first lens unit, a second lens unit, a third lens unit and a fourth lens unit, and wherein the two optical units are formed by the second lens unit and by the third lens unit, and wherein:
the first lens unit has positive refractive power,
the second lens unit has negative refractive power,
the third lens unit has positive refractive power or negative refractive power, and
the fourth lens unit has positive refractive power.

27. The optical system according to claim 13, further comprising:
at least one first intermediate image arranged between the objective and the lens erecting system;
as seen from the objective in the direction of the lens erecting system, a first field lens unit, which has positive refractive power, arranged in front of or behind the first intermediate image;
a second intermediate image arranged between the lens erecting system and the eyepiece along the optical axis; and
as seen from the lens erecting system in the direction of the eyepiece, a second field lens unit, which has positive refractive power or negative refractive power, arranged in front of the second intermediate image.
